(19) United States
(12) Patent Application Publication
(10) Pub. No.: US 2008/0286411 A1
(43) Pub. Date: Nov. 20, 2008

(54) BREAD AND DOUGH COMPOSITION AND METHOD

(75) Inventor: David C. Rettey, Tracy, MN (US)

Correspondence Address: MERCHANT & GOULD PC, P.O. BOX 2903, MINNEAPOLIS, MN, 55402-0903, US

(73) Assignee: Schwan's Food Manufacturing, Inc., Marshall, MN (US)

(21) Appl. No.: 12/181,861

(22) Filed: Jul. 29, 2008

Related U.S. Application Data
(62) Division of application No. 11/065,164, filed on Feb. 23, 2005.

(51) Int. Cl. A21D 8/04; A21D 2/08

(52) U.S. Cl. 426/28; 426/18

(57) ABSTRACT

An enzyme fermented and yeast leavened formulation with a specified rheology can be used in a unique process to provide a high quality bread dough. The dough can be topped with a heat transfer modulator and baked to form a quality product with a bready character and a pleasing crust in a short time.

### CROSS REFERENCE TO RELATED APPLICATION

This application is a divisional of application Ser. No. 11/065,164, filed Feb. 23, 2005, which application is incorporated herein by reference.

### FIELD OF THE INVENTION

The invention generally relates to formulations and processes used in the preparation of dough products that can be baked into a useful food item. The dough formulations can be used in the manufacture of typical bread products including bread, topped or iced rolls, pizza doughs and crusts. More particularly, the invention relates to a process for manufacturing such a bready product from dough with a specified rheology using a short baking period without losing the beneficial properties of the formulations.

### BACKGROUND OF THE INVENTION

Yeast and chemically leavened formulations have been in use for many years to produce a baked bready product from conventional dough formulations having a variety of characteristics. For some time, processes and formulations have been developed that can be used to manufacture a bready product from conventional dough having developed gluten and substantial stiffness. One goal in such a dough and resulting bready product is a light crispy exterior that should be golden brown, a flavorful yeast or buttery character, an irregular, hand made, restaurant or homemade appearance. Often, such yeast or chemically leavened dough formulations are baked at common bread baking temperatures about 350 to 700° F. At such temperatures, typical products bake to a useful product within about 1 to about 60 minutes.

In certain products, made from pita-like formulations, we have found that at these ordinary bread processing conditions, the baked products do not attain a desired bready internal character, but attain a “pita-bread” like characterized by the presence of large void spaces within the baked product and the absence of the desired bread cell structure. Such products do not have a soft, spongy, pleasant texture. Such dough formulations can be relatively quickly baked, but often fail to perform a useful or satisfactory bread product for non-pita applications.

Great attention has been given in recent years to dough formulations that can be prepared and quickly baked into a useful product without loss of bread like character. Examples of such technologies include Freed, U.S. Pat. No. 3,031,306, showing fermented yeast dough using conventional ingredients and an enzyme product derived from mold. Lendvay, U.S. Pat. No. 3,499,765, shows a baked dough and bready product using a fermentation step in the formulation stage. Hansen, U.S. Pat. No. 2,691,592, shows a malted bready product. Lastly, Jeffreys, U.S. Pat. No. 2,842,442, shows a yeast leavened baked product using an Aspergillus culture in combination with a dough formulation.

Even in light of the technologies disclosed in these patents, a substantial need exists for an improved process leading to a quality bread product that can be rapidly baked into a useful, desirable, bready food.

### BRIEF DESCRIPTION OF THE INVENTION

We have developed dough or bread formulation and a quick baking method that can form a quality bread and crust. The formulation uses yeast leavened and enzyme processed formulation with a unique rheology that, when formed and baked under the appropriate heating conditions, results in a quality bread product. The yeast leavening and an enzyme processing in the dough creates the desired Rheology that is soft in physical character and more extensible than common formulations. The dough formulation is characterized by a soft rheology. The dough is easily extensible and has, under similar processing conditions, increased adhesion character. In the process of the invention, the soft dough formulation is prepared and sheeted. The rheology permits the use of the dough in bread products without the need for docking or molding or other steps that impose a shape into the dough. The dough is sheeted and cut into a crust portion. Before baking a material that modulates the rate of heat transfer is placed on the dough. The material modulates heat transfer during baking and controls cooking. In portions modulated, the formulation bakes to a quality bread and desirable cell structure in the bread mass. In portions not modulated, the baking heat obtains a quality exterior crust and desirable cell structure under the crust. The result of the temperature modulation of the soft rheology dough that permits baking the product with a crispy crust and a bready interior. Where modulated, the heat profile and combination of leavening and enzyme processing causes the dough to cook to a bready quality in a reduce time frame.

In this technology, chemical leavening is not indicated and is not necessary. Use of chemical leavening agents can reduce the bready quality of the finished bread. Some small amounts of chemical leavening, however, can be used without harm to the product. Preferred formulations are substantially free of chemical leavening.

### DETAILED DESCRIPTION OF THE INVENTION

A new dough or bread formulation and a quick baking method that be used to form a quality bread and crust. The formulation uses yeast leavened and enzyme processed formulation with a unique Rheology. When formed and baked under the appropriate heating conditions, the formulation obtains a quality bread product. The formulation and processing of the invention results in a soft rheology dough. The dough is easily made into a raw dough preform, is modulated and is baked to form a quality bread. The dough formulation used in the composition of the invention is a soft dough formulation. The unique rheology of the dough formulations is a result, in part, from the addition to the formulation of both amylolytic and proteolytic enzymes. Such enzymes, respectively, catalyze the reduction in molecular weight of starch molecules and protein molecules typically found in the complex starches and proteinaceous gluten of most wheat sources. Such enzymes are readily available in a variety of different preparations. The enzymes are often available in a complex form as the result of the production of malted grain that is then disrupted cellularly releasing the enzymes into the mixture. Alternatively, enzymes can be obtained in a relatively pure form comprising the amylolytic or proteolytic enzymes in a carrier base. As the proteolytic enzymes reduce the molecular weight of natural proteins in the flour, the stiffness of the formulation is substantially reduced resulting, in part, in the desired rheology in the dough formulation of the invention. The amylolytic enzymes present in the formulation tend to reduce the molecular weight of both simple and complex starch molecules reducing the molecular weight substantially to smaller starch molecules additionally contributing to the softness and desired rheology of the dough formulations.

The formulations of the invention also contain a sulfhydryl reducing agent. Such a reducing agent can also permit the use of flour with reduced quality in the dough formulas of the invention without quality loss in the bread product. Many proteinaceous and other natural materials contain disulfide bonds (—S—S—). Such bonds are typically formed by the oxidation of separate sulfhydryl groups that are oxidatively coupled, resulting in a disulfide bond. The reduction of such bonds to two separate sulfhydryl groups (—SH HS—) can result in the reduction in molecular weight of the proteins. The agent can also relax the three dimensional structure of the natural molecules if inter-molecular —S—S-bonds are found. Both such effects tend to reduce the stiffness of the dough producing the desired Rheology of the material. Such reducing agents can be obtained in a form such as L-cysteine. Such relaxed dough materials have a reduced need for mechanical docking or shaping processes that help to maintain the shape and dimensions of the product. The soft rheology of the doughs of the invention permit manufacture of a bready product without need for mechanical docking or extensive shaping of the doughs. The soft materials can be easily formed and are shape retaining during baking and other post formulation steps. Further docking is not needed since, in the products of the invention, the combination of the cooking process and the formulations reduce the tendency of the bread to blister or otherwise deform during baking.

One aspect of the improved product and process of the invention involves the use of a heat modulator that is used to control heat transfer to the dough during baking. The heat modulator material permits use of increased temperatures in the baking process, while maintaining heat transfer to the dough interior at a useful level. The heat modulator permits the exposed surface of the dough to bake into a quality crust, while the modulator covering the surface of the dough permits the covered portions to cook to a bready product. The heat modulator can be used to cover any portion of the exposed surface of the dough, can be used to cover the interior of the dough leaving the exterior exposed or can have any arbitrary pattern of exposed and unexposed portions. For example, a plurality of modulator structures can be formed on the dough in the form of circular portions randomly distributed across the dough surface. Alternatively, the modulator can comprise a material with a randomly distributed series of open zones in the modulator exposing selected portions of the dough surface. In other words, the modulator must cover at least some portion of the dough, but leave some other portion or portions exposed to the effects of heat in the baking process. A variety of materials can be used as the heat modulator. The heat modulator can comprise a structure separate from the final product or can comprise an edible portion of the final product. Separate materials that can act as a heat modulator include foil, cardboard, metal structures, reflective structures or other baking equipment.

The heat modulator can also comprise a portion of the final product. Such heat modulators can include edible material having some substantial heat capacity. Typically, aqueous based materials having a substantial proportion of water are ideal heat modulator materials. Such materials can include aqueous based liquid materials such as icings, gravies, sauces, dispersions of food materials in a water base such as cheese dispersions, fat dispersions, vegetable dispersions, meat dispersions and other materials. As long as the material added to the dough surface has sufficient heat capacity to modulate heat transfer to the interior of the dough during the cooking period, the material qualifies as heat transfer modulator. The typical cooking period for the doughs of this invention range from about 10 to 200 seconds or from about 10 to about 100 seconds. In the case of the use of this technology for the manufacture of pizza foods, heat modulator can be in the form of a sauce application. During the process, a product is created comprising a dough portion with sauce applied to modulate heat directed to the dough surface. This structure is proofed as discussed below and then baked to a final product. The sauce applied to the dough provides important results. First, the sauce acts as a heat modulator and, during the high temperatures of cooking at a relatively short residence time, exposes the crust to appropriate cooking rates. The portion of the crust covered by the sauce is cooked at lower effective temperatures. The periphery of the dough can be cooked to a crust since it is uncovered by the sauce and is exposed to and cooked at higher oven temperatures. This difference in temperature tends to cause the periphery to expand to a greater degree than the covered crust areas that results in the natural formation of a standard crust edge. Further, the sauce tends to promote the formation of a moisture barrier on the surface of the dough during baking. Natural pectins in the sauce act to form a moisture barrier in the dough surface reducing moisture infiltration into the dough mass adding to the quality of the dough after baking. The pH of the sauce is lower than the pH of the dough. We believe that the addition of the sauce to the crust further lowers the pH of the crust at the interface between the sauce and the crust modifying enzymatic action at the interface.

Prior to baking, the crust can obtain an optional oil spray. The oil spray can be applied to the crust at any time prior to baking, however, the oil spray can be applied immediately after sheeting prior to sauce addition or just prior to baking after sauce addition. The application of the oil spray onto the outer crust lip permits baking the outer crust at high heat effect resulting in increased crust expansion at the periphery. The sauce inhibits crust expansion of the interior portion of the dough within the crust lip. As a result, the oil spray promotes the creation of an expanded edge or crust lip since it protects the crust edge during high temperature baking. The resulting characteristics of the crust includes a crisp, more open cell structure on the raised crust edge or lip, while the interior crust is a moist, more closed, modest sized cell structure.

As discussed above, the soft dough sheet is unusually soft. Such dough can be difficult to process. The processability of this soft dough is improved by the addition of a processing adjuvant to reduce adhesiveness. Such an adjuvant can be a particulate such as a corn meal, semolina, etc. onto a surface of the dough that will be in contact with processing equipment or related surfaces. The particulate having a particle size typically in the range of about 10 microns to about 1 mm, often about 150 microns to 750 microns, can be added to the surface of the dough to reduce adhesiveness and improve processability. Such a particulate comprises a range of particle sizes. The particulate can contain at least 10% less than 200 or less than 175 microns and 10% greater than 600 microns. Often a mixture of particulates can be used. Such a particulate can be characterized by a particle size that identifies the peak particle size with a distribution of particles about the central size. A particulate with a nominal size of (e.g.) 600 microns comprises a range of particulate about the central 600 microns size. A mixture of particulate can typically have two, three or more peak sizes. One example of a useful blend is a combination of two particulates with a size greater than 600 microns and a second with a size less than 200 microns, both in an amount of at least 10 wt %. We have found that finely granulated flour, depending on moisture content, has little or no useful effect in improving machinability or processability of the dough in the sheeting or baking function. We have found that corn meal with a larger particle size permits handling or machining of the doughs in common machining applications.

As a result of the formulations developed for the invention disclosed in this application, we have found that the resulting dough, prior to sauce addition and baking, is soft dough. In other words, the dough, through the action of the enzymes reduces the molecular weight and stiffening characteristics of the starch, proteins or crust components to result in a soft crust. The unique dough formulations of the invention combine to produce an improved dough structure. The baker's yeast tends to cleave disulfide bonds in the protein, reducing protein molecular weight and dough softness. The active yeasts act in a typical leavening action on simple carbohydrates in the formulation. Malt enzymes reduce the molecular weight of starch molecules in the formulation to result in a more extensible dough structure. The proteolytic enzymes in the malt preparation interact with gluten, breaks down protein resulting in a softened dough with enhanced extensibility when compared to common dough. The result is a soft unique rheology characterized by its processing characteristics as measured by extensibility and stickiness. In TATX2 Extensibility is the force in grams representing the maximum force measured in distance. Peak force ≦2 gm or ≦0 gm is typical of soft dough. Peak Force 20 to 28 gms at a distance greater than 24 mm also indicates a soft dough. Often the peak force develops at a distance of about 25 to 50 mm. The distance at the point of mechanical failure in the dough mass, (i.e.) the dough mass begins to separate into two portions, as the dough is placed under stress is ≧35 mm and often is ≧30 mm. The dough is quite extensible, is soft and has a rheology characteristic of soft and easily formed dough. Higher forces and reduced distances indicate harder dough of reduced extensibility. A conventional dough is more stiff and is less extensible and can have a peak force of 20 to 21 gms at 20 to 21 mm. The rheology of the dough also shows a stickiness as determined by adhesiveness measured at a range of 1.9 to 2.5 grams at 0.5 to 1.5 seconds. The stickiness indicates the time travel between two anchors. Increased stickiness of the dough shows a reduced processability, but also indicates the softness of the dough.

In the products of the invention, before baking, a heat modulator is added to cover a portion of the dough. In one embodiment, a topping or sauce for the bread product can be applied to about 20 to 95% or 50 to 95% of the exposed or upper surface, as a heat transfer modulator. The modulator can be added to the center of the sheeted dough or to other locations and can be added at an amount of about 10 to 200 or 50 to 150 gm-ft⁻² leaving a crust lip or edge. The topping results in substantial coverage of the dough to about 0.25 to 1″ of the edge. Some dough can be exposed without preventing the desired effect. The sauce or topping has a substantial heat capacity such that it modulates the baking heat at the center of the dough. With a modulated baking heat, the dough cooks at a lower temperature but at a rate, at baking temperatures that results in a quality-baked product having a bready character. The product is then baked at a temperature that ranges from about 250° F. to 850° F. resulting in a quality baked product. In the absence of the topping (and in the absence of an optional oil add-on), the dough attains a bread-like quality. If cooked without the topping, the bread would be characterized by the presence of an open “pita” or a “pocket-like” structure. The sauce application add-on also helps provide a quality crust lip, a moisture barrier on the crust top and other values, and produces results that are consistent. The term processing enzyme includes a proteolytic, diastatic or amylolytic enzyme that reduces the molecular weight or thickening characteristic of a starch or protein resulting in a “softer dough” with a rheology including the extensibility and adhesion as defined by the test methods, data and claims below.

The bread dough formulation of the invention typically comprises an aqueous yeast leavened flour mixture comprising cheese, vegetable oil and a processing enzyme comprising a proteolytic, diastatic or amylolytic enzyme. The formulation, when cooked with the heat transfer modulator, cooks rapidly at elevated temperatures to a bready character with a raised cellular structure from both yeast or chemical leavening. The yeast provides a conventional leavening of the dough. The enzyme components of the aqueous based flour preparation uses an enzyme activity that converts the starch or protein of the flour or other cereal component into improved materials of reduced stiffness due to a reduction in starch or protein molecular weight and also allows the dough to develop a fine bready texture.

Typical flours useful in the process include commonly available commercial flours derived from wheat, rye, and other seed grain materials comprising a gluten and starch content. Typically, wheat flour is preferred, however, other flours or mixtures of flours can be used to produce a useful product using the technology of the invention. The compositions of the invention obtain a useful raised character using conventional leavening agents including natural leavening yeast products. Active yeast materials convert sugars to other products while generating carbon dioxide and ethanol that raise the dough.

The enzyme portion of the relation typically comprises an amylolytic (diastatic) or proteolytic enzyme or mixtures thereof derived from natural sources. These enzymes further aid in the rapid development of the bready character of the dough product. Such enzyme preparations can be prepared from natural sources. “Gluten” is the general term for a mixture of many proteins (called peptide chains or polypeptides) found in common cereal grains. Wheat is the only grain considered to contain true gluten. The peptides that predominate wheat gluten are gliadin and glutenin. However, other proteins occur in rye, barley, and oats. They are secalins, hordeins, and avenins, respectively. Gluten provides strength to the dough through the development of the protein structure by mechanical input when mixing the dough mass. The proteolytic enzyme can act to reduce the stiffness of the dough caused by gluten development.

Food grade reducing agents also used in the invention to improve the texture and other organoleptic characteristics of the bread product made from the dough formulation include available food grade reducing agents. One characteristic group of food grade reducing agent are bisulfite reducing agents such as sodium or potassium bisulfite metabisulfite etc. Thiol reducing agents can be used including reducing agents such as L-cysteine, glutathione and various salts or compositions containing such materials. Inactive yeast can act as a source of reducing agent. Other reducing agents include such compositions as garlic enzyme, autolysed yeast, glutathione, cheese, proteolytic enzymes, and others. We believe the action of reducing agents tends to change the rheology of the gluten matrix resulting in a softer, more acceptable texture in the bread product.

The formulations of the invention can contain a vegetable oil. Useful oils are liquid and freely flowable at application temperature typically about 20° C. to 40° C. and can be sprayed. The oils can be a portion of the formulation or used in the oil spray-on portion of the process. Such oils can be single component oil or blends of oils of various sources. Useful oils include corn oil, soy oil, palm oil, cocoa oil, canola oil, peanut oil, olive oil or other commonly available vegetable oils. Such oils provide richness to the texture and improve the overall flavor and mouth feel of the product.

Such dough can be effectively baked using a process that involves formulating yeast leavened and enzyme processed dough, sheeting the dough, adding the sauce heat transfer modulator to the sheeted dough, proofing thus modulated sheeted dough and baking the proofed dough at an effective temperature. We have found that the addition of the heat transfer modulator to the sheeted dough modulates the temperature increase within the bread during baking to the degree that this portion of the dough forms a bready product. The uncovered edge of the dough acquires a crispy and enlarged edge when compared to the covered modulated area of the bread. As a result of the formulation and process conditions, the resulting baked crust has a desirable edge and a matrix with a bready character characterized by a moist, tender, airy and open cell inside structure, a light bite resistance, a buttery yeasty flavor, a light golden brown color.

In an overall view, the process typically comprises, first, blending all dry ingredients to form a uniform powder mixture. In certain formulations, it is helpful to pre-hydrate certain components of the formulation. For example, yeast, enzyme preparations and additives can be hydrated in water prior to dough manufacture. Once the dry ingredients are added to the mixture, the hydrated mixtures can be added to the dry ingredients followed by the balance of water. The contents of the mixer are agitated until uniform and attain the soft rheology required for the formulation. The soft dough often has increased adhesion and often requires the addition of an agent to the surface of the dough for removal of the mixture from the mixer. Examples of useful materials for dough removal include an oil addition, a flour addition, or a corn meal addition. Once removed from the mixer, the dough can be rested at about ambient temperature, typically 25° C. to 45° C. for 5 to 300 minutes for sufficient time to achieve an increased volume, often an expansion of about 2 to about 4 volumes or preferably about 2.5 to 3.75 volumes can be achieved. The surface of the dough can be maintained soft and tacky by the addition of oil or other surface coatings. The dough is typically sheeted at elevated temperatures that range from about 20° C. to about 35° C. During sheeting, a corn meal anti-stick addition is preferably added to the surface of the dough sheet in contact with the processing equipment to improve processability of the dough and to prevent sticking. The dough is commonly sheeted to a thickness from about 1 to about 5 mm, typically from about 2 to about 3 mm. The sheet is typically cut into round dough pieces or dough pieces of arbitrary shapes for further manufacture. In the instance of pizza manufacture, the dough can be cut into circular or square pizza portions having a major dimension that ranges from about 10 to about 16 inches. A 10 inch crust typically weighs 7 ounces, a 12 inch crust typically weighs 8.5 ounces, while a 14 inch crust typically weighs about 10 ounces. Once cut into a useful shape, then the temperature modulator can be added to the crust. In pizza formation, the temperature modulator is in the form of a pizza sauce that is directly added to the crust. Commonly, the sauce is added to the crust such that the crust is substantially covered leaving a lip that is about 1 to 4 cm in width on the periphery of the crust. The add-on amount of sauce can range from about 20 to about 100 grams, depending on the size of the crust and the peak capacity of the sauce material. Commonly, for a 12 inch crust, the sauce add-on weight is from about 40 to about 60 grams. One substantial advantage of the dough process of the invention relates to the formation of the round or otherwise shaped pizza crust. Typically, pizza crusts are either docked or formed in a heated mold or other shape forming equipment in order to form a round useful bakable crust. Using the doughs of the invention with its unique rheology, the dough can be simply cut from the dough sheet and further processed into the dough portions for pizza crusts of the invention without the use of equipment that imposes a specific shape on the crust, (e.g.) by molding or hot molding processes, or through using docking stations. The dough portion and heat modulator assembly is then (optionally) proofed at elevated temperatures typically above 25° C. and greater than about 50% to 80% relative humidity until the crust expands. An increase in volume of about to about 1.5 to 3 volume increase over the original dough portion volume can be achieved. Once proofed, an optional oil spray can be made onto the surface. The oil add-on ranges up to about 15 gms/ft² more commonly from about 2 to about 10 gms/ft². We have found that after optional oil application, that the crust can be baked at high temperatures for relatively short periods of time. The crust can be baked at a temperature that ranges from about 300 to about 800° F. and can be baked in zones that vary from low temperature to high temperature. In a first zone, the crust can be baked at a temperature from about 300 to about 600° F. In a second zone, the crust can be baked at a temperature from about 400 to about 700° F. and in a third zone at a temperature of about 450 to 800° F. The total time of baking can range from about 10 to about 200 seconds, more commonly about 40 to 120 seconds. After baking, the pizza can be cooled, frozen and packaged as desired. Alternatively, the cooked pizza crust can have a variety of toppings applied before freezing and packaging.

In a preferred mode, the bready product can be used in the form of a pizza crust having a round, square or other arbitrary peripheral shape having a center thickness of about 5 to about 25 millimeters, an edge thickness of about 5 to about 45 millimeters and a major dimension (e.g., square diagonal or circular diameter) of about 10 to about 50 centimeters. Once baked with the modulator applied, the pizza can be further processed through the addition of additional ingredients to the sauce including a variety of meat or meat preparations, cheeses, additional vegetable add-on materials, optional fruits and other edible compositions common in pizza preparation. We have found that the dough formulations of the invention, if not modulated, or mechanically docked or formed and baked at useful temperatures, would result in a “pita-like” bread characterized by large open spaces and the absence of a substantial proportion of bready character. In one preferred embodiment of the invention, the modulated sheeted dough is contacted with an oil spray that further enhances the character of the bread product.

For the purpose of the disclosure, the term “baker's percent” indicates a percentage based on flour, the flour being defined as 100% and each component expressed as a percentage of the flour. The dough formulation comprises a yeast leavened aqueous mixture comprising a major proportion of flour, about 30 to 80%, often 55 to 70% water, about 1 to 200 ppm, often 5 to 90 ppm of a processing enzyme, about 0.1 to 20%, often 2 to 10% of oil (not including the amounts of spray-on oil) and about 0.1 to 15%, often about 0.5 to 5% of cheese or cheese equivalent.

The formulations can have the following:

| Ingredient | Baker's % |
|---|---|
| Flour | 100 |
| Water | 55 to 70 |
| Oil | 2 to 10 |
| Cheese | 0.5 to 5 |
| Yeast | 0.5 to 5 |
| Salt | 1 to 3 |
| Enzyme | 5 to 90 ppm |
| Dough additive | 0 to 90 ppm |

We have also found a formulation that combines a unique yeast/enzyme system that results in dough that can raise and form a bready character and after cooking result in a crispy, bready character in a tender attractive crust. The dough formulations of the invention can be cooked in a thermal oven or on an appropriate susceptor in a microwave oven. The crust component has the following add on ratios:

### Useful Ratios or Amounts of Components

Component

| | | | |
|---|---|---|---|
| Sauce:dough | 1 to 4:8 | 1.25 to 2.5:8 | 1.5 to 2.2:8 |
| weight ratio | | | |
| Oil add-on | 1 to 30 gm-ft⁻² | 2 to 20 gm-ft⁻² | 5 to 15 gm-ft⁻² |
| amount | | | |
| Anti-stick | 0.05 to 1:8 | 0.08 to 0.5:8 | 0.1 to 0.4:8 |
| particulate | | | |
| (Corn | | | |
| meal):Dough | | | |
| Add-on weight | | | |
| ratio | | | |

The premium composition of the invention can have premium quality cheese, sauce and toppings applied to the improved crust material. A variety of typically tomato based sauces, a variety of cheeses and cheese blends can be used in combination with toppings selected from meat sources, fish sources, vegetable sources or fruit sources or other typical topping materials. Pizza sauces can include a variety of ingredients including tomato portions, tomato sauce, tomato paste, various seasonings including salt, herbs and spices.

We have found that the dough formulations of the invention can be sheeted into a bakable form and combined with a heat transfer modulator structure. We have found that the unique yeast/enzyme formulations of the inventions can be rapidly cooked into quality bread like character under the influence of a substantial level of baking heat modulated by a heat transfer modulator structure. Such a modulator structure can comprise a portion of the food or packaging used to prepare the food or can be a component separate from the food.

When used in a pizza product, the dough of the invention can be configured into an individual serving size portion, a serving portion that can satisfy two, three or four individuals, depending on appetite. An individual serving size portion can comprise a circular, semi-circular, oval or other variously shaped crusts having a major dimension of 6 to 8 inches with a thickness of about 3 to 6 millimeters.

In general in formulating the dough, combine dry ingredients and the hydrate the dry ingredients with water initially manufacture the dough formulation. The balance of the ingredients is added and the formulation is blended until substantially uniform. At an increased temperature typically from about 70 to about 90° F., a rest time of 10 to 90 minutes at room temperature or in an environmentally controlled room maintained at or just above ambient, the dough can be sheeted into a useful form and cut, if needed. The sheeted dough can be treated with anti-stick components to improve machining and handling. In the instance that a pizza dough is made, the final dough thickness can range from about 1.5 millimeters to about 1 centimeter and can be formed into crusts of any arbitrary shape with an area of about 20 to about 250 square inches. The heat transfer modulator can then be applied to the sheeted dough. The modulator can be sized to conform identically to the sheeted dough shape or can have a somewhat smaller dimension such that it reveals a peripheral edge, but covers 20 to 95% of the exposed surface. The modulated sheeted dough can then be proofed at common times and temperatures, typically from about 10 to about 60 minutes at a temperature about 70-100° F. and an elevated relative humidity of greater than about 60%, typically 70 to 90%.

The doughs of the invention can be baked in a variety of baking equipment. Conventional thermal ovens and convection ovens can be used to bake the crusts at the high temperatures selected for these materials. However, the baking equipment useful for baking these crusts are not limited to conventional industrial production. The crusts can also be baked in home ovens, wood fired hearths, charcoal and gas fired grills or any other commercial or home baking installation capable of reaching the defined temperatures. The dough can be cooked, without toughening, into a crust having an appealing crispy crust and a soft tender interior.

The modulated proofed sheeted dough can then be baked at relatively high oven temperatures. In one mode of operation, a constant temperature can be used, however, the dough can be baked at a series of varying temperatures. Such temperatures can be applied in zones of different temperatures. Overall, the baking temperature can range from about 350 to about 800° F. Typically, the first zone can range from about 350° to about 700° F., the second zone can be somewhat higher in temperature and can range from about 400 to about 750° F., while in a third zone the temperature can range from about 450 to 800° F. In a continuous process, the dough can be baked in each zone at approximately equal temperatures with a total time of about 30 to about 180 seconds.

An example of a heat modulating sauce for a pizza product is as follows:

### Modulating Sauce

| Sauce (wt.) | Example | Useful Range |
|---|---|---|
| Tomato sauce | 98.0 | 95 to 98% |
| Sugar | 0.20 | 0.0 to 2.0% |
| Salt | 1.3 | 1.0 to 1.5% |
| Oil | 0.15 | 0.0 to 1.0% |
| Spices | 0.25 | 0.20 to .50% |
| Citric acid | 0.10 | 0.05 to 2.0% |

### EXPERIMENTAL

### Example 1

### Formula for Pizza Crust

| Ingredient | Grams | Baker's % |
|---|---|---|
| Flour | 1115.1 | 100.00 |
| Water | 702.5 | 63.00 |
| Oil | 78.97 | 7.08 |
| Cheese | 19.75 | 1.77 |
| Yeast | 25 | 2.24 |
| Salt | 19.75 | 1.77 |
| Enzyme | 0.05 | 0.000045 |
| Dough additive | 0.04 | 0.000036 |

Mixing Procedure
1. Add all dry ingredients to mixer
2. Hydrate the dough additive and enzyme in 1# of water to form a hydrated solution
3. Add remaining ingredients and the hydrated solution to mixer
4. Mix on low speed for 2 minutes
5. Mix on high speed for 5 minutes or until developed
6. A slight amount of oil or dusting flour may be needed to remove the dough from the mixing bowl.
Rest dough in an oil coated container at room temperature for 10 to 240 minutes, either cover or spray with a light coating of oil to prevent skinning. Expected to rise about 3.5× volume.

### Dough Sheeting

Dough temperatures out of mixer target is 70-90° F.
Corn meal should be applied to bottom of the dough sheet prior to the final sheeting roller
Targeted dough final dough thickness is 2.5 mm+1-0.5, at 8.5 oz+/−raw weight for a 12″ crust

Sauce Application
1. Apply 1.75 oz of tomato sauce to raw pizza dough
The sauce should be applied evenly −0.75″ to 1″ of the crust periphery should remain unsauced in 12″ crust.
2. Room temperature sauce

Proofing
1. Proof crusts 30 minutes at 80° F. and 75% RH
2. Expect 2× thickness increase through proofer

Oil spray
1. Spray a light coating of oil to the products prior to entering the high temp oven (target 8.5 g/ft²).

Oven
1. Oven Temperature:

| | | ° F. |
|---|---|---|
| Zone 1 | Top | 350 |
| | Bottom | 500 |
| Zone 2 | Top | 550 |
| | Bottom | 500 |
| Zone 3 | Top | 450 |
| | Bottom | 600 |
| Time | 90 sec | |

Freeze and package
1. Freeze
2. Send to topping line for final topping application

### Example 2A

### Using Previous Process

| Ingredient | Baker's % |
|---|---|
| Flour | 100.00 |
| Water | 65.00 |
| Soy oil | 7.08 |
| Cheese | 1.77 |
| Yeast | 2.24 |
| Salt | 1.77 |
| Enzyme | 0.000045 |
| Dough conditioner | 0.000036 |
| Fermenting enzyme source | 0.71 |
| | 176.58 |

| Ingredient | % |
|---|---|
| Dough | 97.0 |
| Corn meal | 3.0 |
| TOTAL | 100.0 |

### Example 2B

### Crust Weight Variations

### Sauce Amount May Change Once Optimum Amount Determined

| | % | Oz |
|---|---|---|
| Crust | 81.8% | 9.00 |
| Sauce | 18.2% | 2.00 |
| TOTAL | 100% | 11.00 |

### Example 2C

| | % | Oz |
|---|---|---|
| Crust | 81.0% | 8.50 |
| Sauce | 19.0% | 2.00 |
| TOTAL | 100% | 10.50 |

### Example 2D

| | % | Oz |
|---|---|---|
| Crust | 80.0% | 8.00 |
| Sauce | 20.0% | 2.00 |
| TOTAL | 100% | 10.00 |

### Example 3

| Ingredient | % | Baker's % |
|---|---|---|
| Flour | 57.47 | 100.00 |
| Water | 34.73 | 60.44 |
| Soy oil | 4.07 | 7.08 |
| Cheese | 1.02 | 1.77 |
| Yeast | 1.29 | 2.24 |
| Salt | 1.02 | 1.77 |
| Enzyme | 0.0013 | 0.00002 |
| Dough conditioner | 0.002 | 0.00004 |
| Fermenting enzyme source | 0.40 | 0.70 |
| | 100 | 174.01 |
| Dough | 97.7 | |
| Corn meal | 2.3 | |
| TOTAL | 100 | |

### Dough Mixing

Mixing Procedure
1. Add all dry ingredients to mixer
2. Hydrate the dough conditioner and enzyme in water
3. Add remaining ingredients and above solution to mixer
4. Mix on low speed for 2 minutes
5. Mix on high speed for 5 minutes or until developed
6. A slight amount of oil or dusting flour may be needed to remove the dough from the mixing bowl
Rest dough in an oil coated trough at room temperature for 60 minutes, either cover or spray with a light coating of oil to prevent skinning. Expected to rise up to 4× volume.

### Dough Sheeting

1. Corn meal should be applied to bottom of the dough sheet prior to the final sheeting roller
2. Targeted dough final dough thickness is 2.0 mm+1-0.5, at 8 oz+/−raw weight for a 12″ crust

### Sauce Application

1. Applicator to get 2 oz or determined target weight
2. Apply heat modulating sauce to pizza crust leaving a 0.75° lip exposed—sauce should spread for full coverage
3. Room temperature sauce

### Proofing

1. Proof crusts 30 minutes at 80° F. and 75 RH (keep constant for all legs)
2. Expect 2× thickness increase through proofer

### Oil Spray

1. Spray a light coating of oil to the products prior to entering the high temperature oven (target 8.5 g/ft²)

### Oven

1. Set high temperature oven to previous settings as reference starting point
2. Oven Temperature:

| | | ° F. |
|---|---|---|
| Zone 1 | Top | 400 |
| | Bottom | 525 |
| Zone 2 | Top | 550 |
| | Bottom | 400 |
| Zone 3 | Top | 500 |
| | Bottom | 700 |
| Time | 90 sec | |

3. Adjustments will be needed to the oven settings to optimize performance:

### Freeze and Package

Freeze crusts and send to topping area for further processing

### Extensibility Test

The test is used to measure the extensibility of dough and measure of gluten quality. A TA-XT2 test device is used with a Kieffer dough and gluten extensibility rig (A/KIE) using 5 kg load cell.

### Test Conditions

TA-XT2 Settings

| Mode: | Measure Force in Tension | |
|---|---|---|
| Option: | Return to Start | |
| Pre-Test Speed: | 2.0 | mms |
| Test Speed: | 3.3 | mm/s |
| Post-Test Speed: | 10.0 | mm/s |
| Distance: | 75 | mm |
| Trigger Force: | Auto - 5 | g |
| Data Acquisition Rate: | 200 | pps |

A sample is prepared by applying a small amount of oil to both sides of the teflon dough form, to avoid sample adhesion. A chosen mass (e.g. ˜15 gms) of the prepared dough/gluten sample is placed onto the grooved base of the form. Position the upper block of the form on top of the sample and push down firmly until the two blocks come together. Remove excess dough cleanly from sides, using a knife/spatula and clamp the dough form in the form press for 40 minutes (this cuts the sample into strips, allows the dough/gluten to relax and prevents loss of moisture). Scrape off any excess dough/gluten sample that is forced out from the sides of the form. Loosen the dough press and carefully slide the upper form block backwards over the grooved base to uncover the first dough/gluten strip. Tighten the press in this position, and using the upper form block as a cutting edge, score along the ridge of a groove to separate the strip of dough. To remove the strip of dough/gluten from the grooved base, dip the spatula in oil, and carefully slide it under the sample. Take care not to stretch or deform the dough/gluten sample. The first and last few strips may not be of full length, so these should be discarded.

To test the sample, position the Kieffer rig on the machine base. Ensure that the hook probe is covered with the plastic sleeve to prevent it from shearing through the sample. Lower the hook probe to just above the upper surface of the spring-loaded clamp. Place the strip of dough/gluten onto the grooved region of the sample plate and, holding down the spring loaded clamp lever, insert the plate into the rig. Release the handle slowly. Commence the tensile test and repeat the results recording peak force units, distance at peak force and distance to dough failure.

### Dough Adhesion/Stickiness Test

The test is a measure of dough stickiness. A TA-XT2 test device is used with 25 mm perspex cylinder probe (P/25P) using 5 kg load cell SMS/CHen-Hoseney Dough Stickiness Cell (A/DSC).

### Test Conditions

TA-XT2 Settings

| Option: | Adhesive Test | |
|---|---|---|
| Pre-Test Speed: | 0.5 | mm/s |
| Test Speed: | 0.5 | mm/s |
| Post-Test Speed: | 10.0 | mm/s |
| Distance: | 4 | mm |
| Force: | 40 | g |
| Time: | 0.1 | s |
| Trigger Type: | Auto - 5 | g |
| Data Acquisition Rate: | 500 | pps |

Before using the cell, rotate the internal screw to move the piston and increase the sample chamber to its maximum capacity. Place a small quantity of prepared dough into the chamber and remove the excess dough with a spatula so that it is flush with the top of the chamber. Screw on the extruder lid. Rotate the internal screw a little way to extrude a small amount of dough through the holes and remove this first extrusion from the lid surface using a spatula. Rotate the screw once again to extrude a 1 mm high dough sample. Place the perspex cap over the exposed sample surface to minimize moisture loss (if moisture loss appears to be a problem, while waiting for the dough to relax, place a moist piece of filter paper under the perspex cap), while allowing the prepared dough surface to rest for 30 seconds to release the stress produced by extrusion. After this time, remove the cover and place the cell directly under the 25 mm cylinder probe attached to the load cell.

Commence the adhesive test.

The dough can then be removed from the lid surface and extruded again to repeat the test, using the above procedure, report the results as force units at a time after test initiation.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A process for preparing a topped bread product, the process comprising the steps:
(a) formulating an aqueous yeast leavened dough product comprising flour, about 2 to 10 baker's percent oil; about 1 to 5 baker's percent cheese and;
(b) sheeting the dough formulation to a thickness of about 1.5 to 10 millimeters producing a sheeted formulation;
(c) applying a heat transfer modulator to the sheeted formulation in an amount of about 20 to about 90% of the surface to form a modulated sheet;
(d) proofing the modulated sheet at a temperature of greater than about 70° F. for greater than 10 minute to form a proofed sheet; and
(e) baking the proofed sheet at a temperature that ranges from about 250° F. to about 850° F. for greater than about 30 sec.

2. The process of claim 1 wherein the dough comprises about 0.01 to 0.5 baker's percent of an enzyme blend comprising a proteolytic and an amylolytic enzyme to form a dough formulation.

3. The process of claim 1 wherein the oil is added to the modulated sheet in an amount of about 5 to about 15 gm.-ft.⁻².

4. The process of claim 1 wherein the proofed sheet is baked at a temperature initially in the range of 350°-700° F. for greater than 10 sec., subsequently at a temperature that ranges from about 400°-750° F. for greater than 10 sec. and finally at a temperature that ranges from about 450°-850° F. for greater than 10 sec.

5. The process of claim 1 wherein the proofed sheet is baked for a total period of time that ranges from about 0.5 to 3 minutes.

6. The process of claim 1 wherein the topping to sheeted formulation weight ratio is from about 0.1 to 1:1.

7. The process of claim 1 wherein the enzyme blend comprises a malt product.

8. The process of claim 1 wherein the sheet is proofed at a temperature that ranges from about 75 to about 110° F. at a humidity greater than about 60° RH for a period of time of at least 10 minutes.

9. The process of claim 1 wherein the dough product is formulated at a temperature greater than about 70° F. measured at mixer.

10. The process of claim 1 wherein about 5 to about 10 grams/ft⁻² of corn meal is applied to the bread product bottom surface.

11. A process for preparing a topped pizza crust, the process comprising the steps:
(a) formulating an aqueous yeast leavened dough product comprising flour, oil, baker's yeast and an enzyme;
(b) sheeting and cutting the dough formulation to portion having a thickness of about 1.5 to about 10 millimeters;
(c) applying a liquid pizza sauce heat modulator to the portion in an amount such that about 20 to 90% of the surface is covered with the modulator forming a modulated sheet; and
(d) baking the modulated sheet at a temperature that ranges from about 250° F. to about 850° F. for about 30 to 120 seconds.

12. The method of claim 11 wherein the liquid heat modulator comprises a sauce added to the portion to less than 0.5 inches of an edge.

13. The method of claim 12 wherein the sauce comprises a tomato sauce.

14. The method of claim 11 wherein the sheet is baked at a temperature that ranges from about 300° F. to about 800° F. for about 30 to 120 seconds.

15. The method of claim 11 wherein the portion is formed into its final geometry without docking or pressing.
